(19) United States
(12) Patent Application Publication
(10) Pub. No.: US 2025/0331066 A1
(43) Pub. Date: Oct. 23, 2025

(54) MOTION-SENSOR-INTEGRATED FLAT HEATING SHEET, AND MANUFACTURING METHOD THEREFOR

(71) Applicant: Mcell Co., Ltd., Seongnam-si Gyeonggi-do (KR)

(72) Inventors: Seung Hyun Jee, Gyeonggi-do (KR); You Na Lee, Gyeonggi-do (KR)

(73) Assignee: Mcell Co., Ltd., Seongnam-si Gyeonggi-do (KR)

(21) Appl. No.: 18/867,740

(22) PCT Filed: May 26, 2023
(86) PCT No.: PCT/KR2023/007276

§ 371 Date: Nov. 20, 2024

(30) Foreign Application Priority Data
May 31, 2022 (KR) 10-2022-0066547

(51) Int. Cl. H05B 1/02; H05B 3/03; H05B 3/14; H05B 3/34

(52) U.S. Cl. CPC H05B 1/0238; H05B 3/03; H05B 3/145; H05B 3/345; H05B 3/347; H05B 2203/007; H05B 2203/017; H05B 2203/029; H05B 2214/04

(57) ABSTRACT

A motion-sensor-integrated flat heating sheet and a manufacturing method therefor are disclosed. According to one aspect of the present disclosure, there may be provided a motion-sensor-integrated flat heating sheet that includes: a heating sheet part including a first fabric, a patterned heating layer formed on one surface of the first fabric and constituted with a plurality of carbon nanotubes, and a first electrode electrically connected to the patterned heating layer; and a sensor sheet part comprising a second fabric, a self-assembled monolayer formed on one surface of the second fabric and including functional groups, a carbon nanotube layer formed by adsorbing a plurality of carbon nanotubes onto the self-assembled monolayer, and a second electrode electrically connected to the carbon nanotube layer, wherein the sensor sheet part is attached to the other surface of the first fabric.

### TECHNICAL FIELD

The present disclosure relates to a motion-sensor-integrated flat heating sheet and a manufacturing method therefor.

### BACKGROUND ART

Currently, the types of convenience features applied to automobiles are gradually increasing, and there have especially been active investments in convenience devices related to automobile seats where drivers and passengers sit.

Conventionally, metal wire-based heating systems have been applied to car seats for winter heating.

However, the metal wire heating system has posed several issues, including high manufacturing costs resulting in reduced profitability of car manufacturers, risks of burn accidents for passengers and fire accidents in vehicles, and increased warranty service costs due to broken wires.

Moreover, the heat control without taking passenger movements into consideration has been leading to low energy efficiency, which is undesirable, particularly in terms of battery management of electric vehicles, which are increasing market share.

The technology that forms the basis of the present disclosure is disclosed in Korean Patent Registration No. 10-1768665 (Aug. 17, 2017, Wearable Sensor and Manufacturing method therefor) and Korean Patent Registration No. 10-2076767 (Feb. 12, 2020, Heating Textile and Manufacturing method therefor).

### DETAILED DESCRIPTION OF THE DISCLOSURE

### Technical Problem

The embodiments of the present invention provide a motion-sensor-integrated flat heating sheet and a manufacturing method therefor, which has a heating structure with better durability and lower power consumption than conventional metal wire systems, and which allows for energy-efficient heat control taking passenger movement into consideration.

### Technical Solution

According to one aspect of the present disclosure, there is provided a motion-sensor-integrated flat heating sheet that includes: a heating sheet part including a first fabric, a patterned heating layer formed on one surface of the first fabric and constituted with a plurality of carbon nanotubes, and a first electrode electrically connected to the patterned heating layer; and a sensor sheet part comprising a second fabric, a self-assembled monolayer formed on one surface of the second fabric and including functional groups, a carbon nanotube layer formed by adsorbing a plurality of carbon nanotubes onto the self-assembled monolayer, and a second electrode electrically connected to the carbon nanotube layer, wherein the sensor sheet part is attached to the other surface of the first fabric.

The first fabric may be made of woven fabric.

The second fabric may be made of knit fabric.

The patterned heating layer may have a continuous mesh structure with openings formed on one surface of the first fabric, wherein the openings may serve as ventilation holes for a ventilated seat.

The sensor sheet part may detect resistance changes in the carbon nanotube layer caused by deformation of the second fabric, and the heating sheet part may control the power supplied to the patterned heating layer based on results of detection by the sensor sheet part.

According to another aspect of the present disclosure, there is provided a manufacturing method for a motion-sensor-integrated flat heating sheet, the method comprising: preparing a dispersion solution by dispersing a plurality of carbon nanotubes in a dispersion medium; manufacturing a heating sheet part by providing the dispersion solution to one surface of a first fabric to form a patterned heating layer and forming a first electrode electrically connected to the patterned heating layer; manufacturing a sensor sheet part by forming a self-assembled monolayer containing functional groups on one surface of a second fabric, providing the dispersion solution on the self-assembled monolayer to form a carbon nanotube layer, and forming a second electrode electrically connected to the carbon nanotube layer; and attaching the sensor sheet part to the heating sheet part such that the sensor sheet part is positioned on the other surface of the first fabric.

### Effects of the Disclosure

According to the embodiments of the present disclosure, the heating structure has less power consumption and better durability than conventional metal wire systems, and it is possible to control heating with the movement of passengers into consideration, thereby improving energy efficiency.

### BRIEF DESCRIPTION OF THE DRAWINGS

FIG. 1 is a diagram showing a motion-sensor-integrated flat heating sheet according to an embodiment of the present disclosure.

FIG. 2 is a cross-sectional view of the heating sheet part shown in FIG. 1.

FIG. 3 is a cross-sectional view of the sensor sheet part shown in FIG. 1.

FIG. 4 is a conceptual diagram illustrating the bonding principle of the self-assembled monolayer.

FIG. 5 is a flow diagram illustrating the method of manufacturing a motion-sensor-integrated flat heating sheet according to an embodiment of the present disclosure.

### BEST MODE FOR EMBODIMENT OF THE DISCLOSURE

Hereinafter, preferred embodiments of the present disclosure will be described in detail with reference to the accompanying drawings.

Unless explicitly defined otherwise, the terms used in the embodiments of the present disclosure are to be interpreted as commonly understood by those skilled in the art to which the disclosure pertains. These terms are intended solely for the purpose of describing specific embodiments and are not intended to limit the disclosure.

In the present specification, singular terms should be interpreted to include the plural unless context clearly dictates otherwise.

Furthermore, when a certain part is described as “including” or “comprising” a particular element, it shall be understood that the part may further include additional elements.

When an element is described to be “on” another element, this may refer to either above or below that element and does not necessarily mean being positioned on an upper side in the gravitational direction.

Moreover, when an element is described as being “connected” or “coupled” to another element, this may include that the element is not only directly connected or coupled to the other element but also indirectly connected or coupled to the other element via yet another element.

Additionally, the terms “first,” “second,” and so forth may be used to distinguish elements from each other, and these terms are not intended to inherently limit the nature, order, or sequence of the elements.

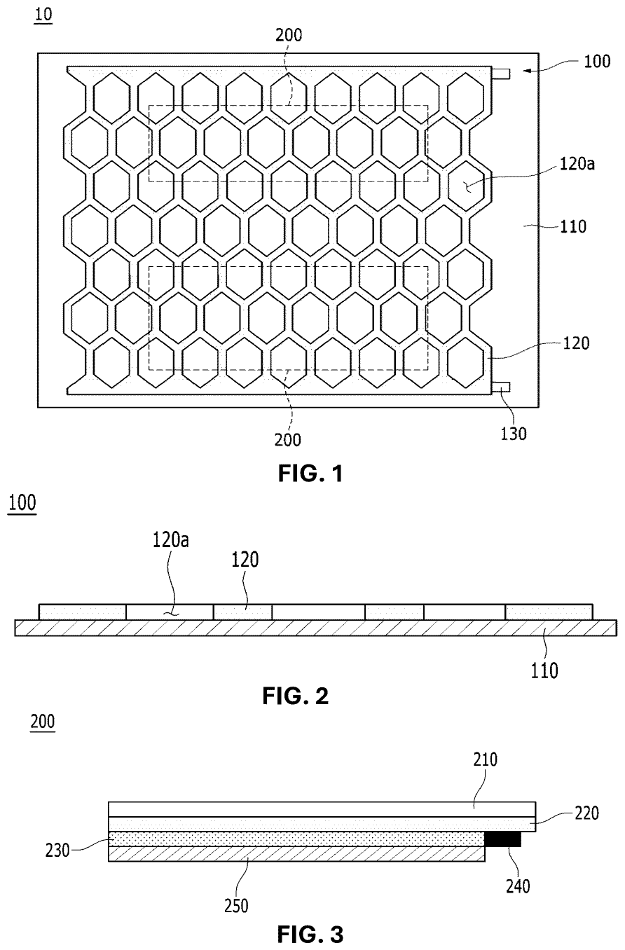

FIG. 1 is a diagram showing a motion-sensor-integrated flat heating sheet according to an embodiment of the present disclosure. FIG. 2 is a cross-sectional view of the heating sheet part shown in FIG. 1. FIG. 3 is a cross-sectional view of the sensor sheet part shown in FIG. 1.

Referring to FIGS. 1 through 3, a motion-sensor-integrated flat heating sheet 10 according to one embodiment of the present disclosure may include a heating sheet part 100 and a sensor sheet part 200.

The heating sheet part 100 may be configured to perform a heating function by coating carbon nanotubes in ink form onto a textile substrate. Specifically, the heating sheet part 100 may be configured to carry out a thin, lightweight, and flexible far-infrared emission type planar heating function through a simple process of embroidering conductive yarn onto the textile substrate to pattern electrodes, coating carbon nanotubes, and then forming a protective layer.

The heating sheet part 100 may include a first fabric 110, a patterned heating layer 120, and a first electrode 130.

The first fabric 110 may be made of a stretchable and durable woven fabric.

The patterned heating layer 120 may be formed on one surface of the first fabric 110 and may be constituted with a plurality of carbon nanotubes. Here, a carbon nanotube (CNT) may be a nano-material in tube form made up of a sheet of graphite in which six carbon atoms are bonded in a hexagonal shape, with a diameter ranging from a few nanometers to several hundred nanometers.

The patterned heating layer 120 may be configured with a continuous mesh structure that forms openings 120a on one surface of the first fabric 110.

The openings 120a may refer to portions where the patterned heating layer 120 is not formed, exposing the one surface of the first fabric 110 to the exterior.

Therefore, the openings 120a may function as ventilation holes in an automotive ventilated seat. That is, if a heating layer is formed across the entire area of the first fabric 110, air supplied from a blower beneath the flat heating sheet would be obstructed by the heating layer and would not reach the passenger seated on the flat heating sheet. However, the openings 120a will serve as ventilation holes, allowing for smooth airflow.

The first electrode 130 may be configured to electrically connect the patterned heating layer 120 to an external power source (not shown).

By flowing current to the patterned heating layer 120 through the first electrode 130, the patterned heating layer 120 may be electrically heated (or resistively heated).

The sensor sheet part 200 may be attached to the heating sheet part 100, for example, through a hot-melt layer.

For instance, the sensor sheet part 200 may be attached to the other surface of the first fabric 110 to be disposed in an overlapping vertical arrangement with the patterned heating layer 120.

Thus, it is possible for the sensor sheet part 200 to perform precise heat control by analyzing the posture, movement, muscle fatigue, body temperature, respiration, electrocardiogram, etc., of the passenger seated on the patterned heating layer 120.

The sensor sheet part 200 may include a second fabric 210, a self-assembled monolayer 220, a carbon nanotube layer 230, and a second electrode 240, and may further include a protective layer 250.

The second fabric 210 may be made of a highly stretchable knit fabric for motion detection.

The second fabric 210 may have the self-assembled monolayer 220 and the carbon nanotube layer 230 formed on one surface thereof, and the other surface of the second fabric 210 may be attached to the other surface of the first fabric 110.

The self-assembled monolayer 220 may be formed on one surface of the second fabric 210 and may include functional groups.

By forming the self-assembled monolayer 220 on one surface of the second fabric 210 to treat the surface of the second fabric 210, the bonding strength between the second fabric 210 and the carbon nanotube layer 230 may be enhanced.

The carbon nanotube layer 230 may be formed by adsorbing a plurality of carbon nanotubes onto the self-assembled monolayer 220.

The electrical resistance of the carbon nanotube layer 230 may vary depending on the change in surface area of the carbon nanotube layer 230 or the change in the number of contact points between the plurality of carbon nanotubes, and the sensor sheet part 200 may detect the change in electrical resistance of the carbon nanotube layer 230 caused by deformation of the second fabric 210, thereby analyzing the posture, movement, muscle fatigue, body temperature, respiration, electrocardiogram, etc., of the passenger. The sensing values detected by the sensor sheet part 200 and the information analyzed based on these values may be used to control the power supplied to the patterned heating layer 120 of the heating sheet part 100.

The second electrode 240 may be configured to electrically connect the carbon nanotube layer 230 to a resistance measurement device (not shown).

The protective layer 250 may be coated on the carbon nanotube layer 230, may address an issue of possible delamination of the carbon nanotube layer 230 due to excessive or sudden deformation of the second fabric 210, and may also alleviate stress on the carbon nanotube layer 230.

Although the protective layer 250 may be made of resin, it is not limited to this material and may be made of any flexible material with excellent elasticity that is capable of stretching in response to deformation of the second fabric 210.

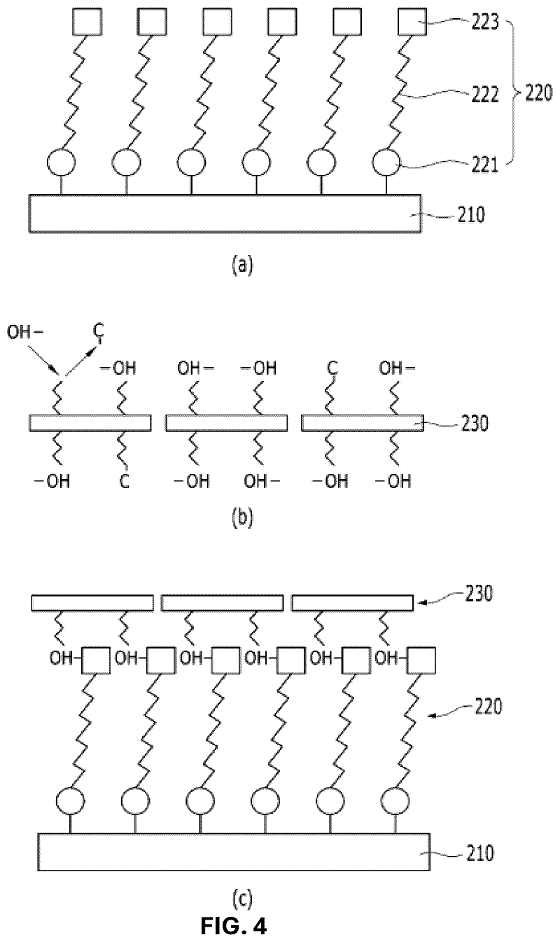

FIG. 4 is a conceptual diagram illustrating the bonding principle of the self-assembled monolayer.

Referring to FIG. 4, the self-assembled monolayer 220 may include a root group 221, which binds to the surface of the second fabric 210, and a functional group 223, which is connected to the root group 221, and may further include a backbone 222, which connects the root group 221 and the functional group 223.

The root group 221 may bind to the surface of the second fabric 210 and may be selected according to the type of the second fabric 210. Typically, a substance containing silicon atoms (Si), such as silane, may be chosen.

The backbone 222 may be primarily constituted with an alkyl chain and may be a hydrocarbon chain or a fluoro-carbon chain.

The functional group 223 may include a functional group that is capable of providing specific functionalities and may be selected from a variety of functional groups depending on the material to be attached.

Here, the functional group may include at least one selected from the group consisting of an amine group, an amino group, a thiol group, a carboxyl group, a formyl group, a cyanate group, a silanol group, a phosphine group, a phosphonate group, a sulfonate group, and an epoxy group.

Accordingly, the surface of the second fabric 210 may be positively (+) charged to impart electrostatic force, and when a hydroxyl group is formed on the surface of the carbon nanotube layer 230, the bonding strength between the second fabric 210 and the carbon nanotube layer 230 (i.e., the bonding strength between the self-assembled monolayer 220 and the carbon nanotube layer 230) may be improved.

Meanwhile, to ensure that the root group 221 binds well to the surface of the second fabric 210, the surface of the second fabric 210 may be activated to form hydroxyl groups on the surface of the second fabric 210.

Moreover, the self-assembled monolayer may be formed on one surface of the first fabric 110 to improve the bonding strength between the first fabric 110 and the patterned heating layer 120. A protective layer (not shown) may also be formed on the patterned heating layer 120 to protect the patterned heating layer 120. An insulating layer (not shown) may be formed on the other surface of the first fabric 110 to minimize the discharge and loss of heat generated by the patterned heating layer 120 to the outside through the first fabric 110 or the impact on the sensor sheet part 200.

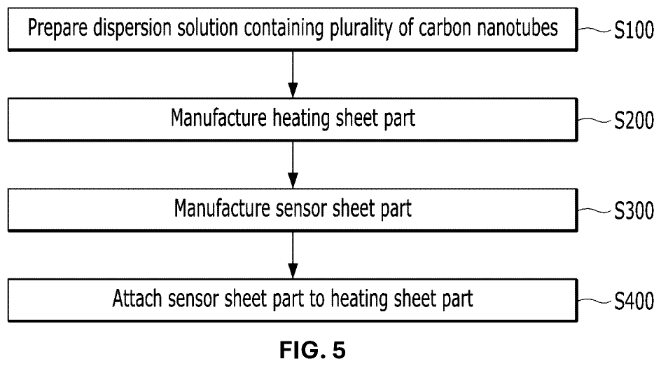

FIG. 5 is a flow diagram illustrating the method of manufacturing a motion-sensor-integrated flat heating sheet according to an embodiment of the present disclosure.

Referring to FIG. 5, the method of manufacturing a motion-sensor-integrated flat heating sheet according to an embodiment of the present disclosure may include: preparing a dispersion solution containing a plurality of carbon nanotubes (S100), manufacturing a heating sheet part (S200), manufacturing a sensor sheet part (S300), and attaching the sensor sheet part to the heating sheet part (S400).

First, a dispersion solution may be prepared by dispersing a plurality of carbon nanotubes in a dispersion medium (S100).

Here, the carbon nanotubes may have hydroxyl groups formed on surfaces thereof or may have at least part of the carbon bonding removed from surfaces thereof. The dispersion medium may be, but not limited to, ultrapure water (DI water). For example, the dispersion process may be performed by adding carbon nanotubes (e.g., 30 mg) to ultrapure water (e.g., 1 liter) and stirring the mixture for 18 to 30 hours.

Next, a patterned heating layer 120 may be formed by providing the dispersion solution on one surface of a first fabric 110, and a heating sheet part 100 may be manufactured by forming a first electrode 130 electrically connected to the patterned heating layer 120 (S200).

The patterned heating layer 120 may be formed by using, for example, a vacuum adsorption method or screen printing method, with the pattern formed in a continuous mesh structure through, for example, silk screening (or masking).

Then, a self-assembled monolayer 220 containing functional groups may be formed on one surface of the second fabric 210, and a carbon nanotube layer 230 may be formed by providing the dispersion solution on the self-assembled monolayer 220. Additionally, a sensor sheet part 200 may be manufactured by forming a second electrode 240 electrically connected to the carbon nanotube layer 230 (S300).

The carbon nanotube layer 230 may also be formed using, for example, the vacuum adsorption method.

Finally, a flat heating sheet 10 may be manufactured by attaching the sensor sheet part 200 to the heating sheet part 100 such that the sensor sheet part 200 is positioned on the other surface of the first fabric 110 (S400).

Hitherto, certain preferred embodiments of the present disclosure have been described, but these are merely examples and are not intended to limit the disclosure thereto. Anyone skilled in the art to which the present invention pertains will understand that various modifications and permutations may be made to the embodiments by way of, for example, addition, alteration, deletion, or supplementation of elements, without departing from the technical ideas of the disclosure as defined in the claims appended hereto. It shall also be appreciated that such modifications and permutations fall within the scope of the rights of the present disclosure.

1. A motion-sensor-integrated flat heating sheet comprising:
a heating sheet part comprising a first fabric, a patterned heating layer formed on one surface of the first fabric and constituted with a plurality of carbon nanotubes, and a first electrode electrically connected to the patterned heating layer; and
a sensor sheet part comprising a second fabric, a self-assembled monolayer formed on one surface of the second fabric and comprising functional groups, a carbon nanotube layer formed by adsorbing a plurality of carbon nanotubes onto the self-assembled monolayer, and a second electrode electrically connected to the carbon nanotube layer,
wherein the sensor sheet part is attached to the other surface of the first fabric.

2. The motion-sensor-integrated flat heating sheet according to claim 1, wherein the first fabric is made of woven fabric.

3. The motion-sensor-integrated flat heating sheet according to claim 1, wherein the second fabric is made of knit fabric.

4. The motion-sensor-integrated flat heating sheet according to claim 1, wherein the patterned heating layer has a continuous mesh structure with openings formed on one surface of the first fabric, and
wherein the openings function as ventilation holes in a ventilated seat.

5. The motion-sensor-integrated flat heating sheet according to claim 1, wherein the sensor sheet part detects resistance changes in the carbon nanotube layer caused by deformation of the second fabric, and
wherein the heating sheet part controls the power supplied to the patterned heating layer based on results of detection by the sensor sheet part.

6. A method of manufacturing a motion-sensor-integrated flat heating sheet, the comprising:
preparing a dispersion solution by dispersing a plurality of carbon nanotubes in a dispersion medium;
manufacturing a heating sheet part by providing the dispersion solution to one surface of a first fabric to form a patterned heating layer and forming a first electrode electrically connected to the patterned heating layer;
manufacturing a sensor sheet part by forming a self-assembled monolayer containing functional groups on one surface of a second fabric, providing the dispersion solution on the self-assembled monolayer to form a carbon nanotube layer, and forming a second electrode electrically connected to the carbon nanotube layer; and
attaching the sensor sheet part to the heating sheet part such that the sensor sheet part is positioned on the other surface of the first fabric.
